(19) United States
(12) Patent Application Publication
(10) Pub. No.: US 2021/0089617 A1
(43) Pub. Date: Mar. 25, 2021

(54) PASTING BASED ON SEMANTIC FRAGMENTS

(71) Applicant: International Business Machines Corporation, Armonk, NY (US)

(72) Inventors: Wei Li, Beijing (CN); Lan Qian Peng, Beijing (CN); Xin Xin Dong, Beijing (CN); Zhi Dan Hao, Beijing (CN); Yi Jie Ma, Beijing (CN)

(21) Appl. No.: 16/580,810

(22) Filed: Sep. 24, 2019

(51) Int. Cl. G06F 17/24; G06F 17/27; G06F 3/0482; G06F 3/0486; G06F 3/0488

(52) U.S. Cl. CPC G06F 17/24; G06F 17/2785; G06F 3/04883; G06F 3/0482; G06F 3/0486; G06F 17/2705

(57) ABSTRACT

Aspects of the present invention disclose a method for pasting based on semantic fragments. The method includes one or more processors in response to identifying a copy operation request, obtaining copied data. The method further includes splitting the copied data into a plurality of semantic fragments based on semantic analysis. The method further includes rendering the plurality of semantic fragments on a display of a computing device. The method further includes in response to identifying a user selection of at least one of the plurality of semantic fragments, determining whether to paste the at least one of the plurality of semantic fragments.

### BACKGROUND OF THE INVENTION

The present disclosure relates to data processing, and more specifically, to pasting based on semantic fragments of text.

Copy and paste operations are common for users of electronic devices, such as mobile phones and computers. For example, a user may copy data from a source and paste the copied data into a destination.

### SUMMARY

Aspects of the present invention disclose a method, computer program product, and system for pasting based on semantic fragments. The method includes one or more processors in response to identifying a copy operation request, obtaining copied data. The method further includes one or more processors splitting the copied data into a plurality of semantic fragments based on semantic analysis. The method further includes one or more processors rendering the plurality of semantic fragments on a display of a computing device. The method further includes in response to identifying a user selection of at least one of the plurality of semantic fragments, one or more processors determining whether to paste the at least one of the plurality of semantic fragments.

### BRIEF DESCRIPTION OF THE DRAWINGS

Through the more detailed description of some embodiments of the present invention in the accompanying drawings, the above and other objects, features and advantages of the present invention will become more apparent, wherein the same reference generally refers to the same components in the embodiments of the present invention.

FIG. 1 depicts a cloud computing node, in accordance with an embodiment of the present invention;

FIG. 2 depicts a cloud computing environment, in accordance with an embodiment of the present invention;

FIG. 3 depicts abstraction model layers, in accordance with an embodiment of the present invention

FIG. 4A depicts a block diagram of an exemplary system in which embodiments of the present invention can be implemented, in accordance with an embodiment of the present invention;

FIG. 4B depicts a block diagram of another exemplary system in which embodiments of the present invention can be implemented, in accordance with an embodiment of the present invention;

FIG. 5 is a flowchart depicting operational steps of an example program 500 for a paste operation, in accordance with embodiments of the present invention;

FIG. 6A depicts a schematic diagram of an example of information extraction based on semantic analysis, in accordance with embodiments of the present invention;

FIG. 6B depicts a schematic diagram of an example of a plurality of semantic fragments according to information extraction, in accordance with embodiments of the present invention;

FIG. 7A depicts an example user interface (UI) according to an embodiment of the present invention in which an example of the plurality of semantic fragments rendered and one selected fragment to be pasted in the specified field is shown, in accordance with embodiments of the present invention;

FIG. 7B depicts an example user interface (UI) according to an embodiment of the present invention in which the selected semantic fragments pasted in a specified field are shown, in accordance with embodiments of the present invention; and

FIGS. 8A and 8B depicts a schematic diagram of an example method of copy operation in which a graphic is drawn by the user using the, in accordance with embodiments of the present invention.

### DETAILED DESCRIPTION

Embodiments of the present invention allow for selective visualized pasting of fragments of replicated textual data. Embodiments of the present invention extracts textual data of a selected location of display of a device. Additional embodiments of the present invention segments textual data into two or more phrase sets, which a user can select individually to paste in another location.

Some embodiments of the present invention recognize that existing solutions for copy and paste operations to select textual data from a continuous data set (e.g., a paragraph) are time consuming and laborious. For example, a user utilizes a touch sensitive screen of an electronic device, to long press a location of textual data on the touch sensitive screen of the electronic device. Additionally, a portion of the textual data may be highlighted and two (2) movable cursors may appear to the left and right sides of the highlighted textual data respectively. In this example, the user may have to reposition the cursors to change the range of textual data selected for copying, and the selected textual data is normally continuous contents (i.e., one phrase, sentence, paragraph, etc.). Furthermore, the user may select a copy command to copy the selected textual data (i.e., the continuous contents), then select a specified field (e.g., another location of an operating system of the electronic device) and select a paste command to paste the selected textual data into the specified field. Thus, if the user would like to copy and paste fragments of the textual data, then the user must perform a plurality of copy and paste operations or copy and paste all the data once then edit the data pasted, such as delete undesired contents.

Additional embodiments of the present invention recognize the level of difficulty required to locate the cursors to accurately position the cursors to select textual data when editing on the touch sensitive screen with a limited size and the absence of visibility of the selected textual data in the clipboard.

Various embodiments of the present invention resolve these issues by providing a visible, flexible and convenient copying and pasting operation. Embodiments of the present invention can be useful for scenarios where a user needs to paste only parts of the copied textual data. In some embodiments of the present invention, after a user copies the textual data, textual analytics is utilized to divide the textual data into a plurality of semantic fragments, and the fragments are provided to a user for selection.

Embodiments of the present invention provide a user the ability to subjectively select a fragment of copied textual data to paste. Thus, eliminating repeated copy and paste operations or unnecessary editing operations on the pasted data may be avoided reducing the amount of processing resource utilized to perform the intended operation. In addition, a plurality of fragments is provided to a user on a screen, so that the contents to be pasted are visible, which makes the paste operation more accurate and convenient. These improvements and/or advantages are a non-exhaustive list of example advantages provided by the present invention. Embodiments of the present invention exist, which may include none, some, or all of the aforementioned advantages and/or improvements.

Implementation of embodiments of the invention may take a variety of forms, and exemplary implementation details are discussed subsequently with reference to the Figures. Various embodiments will be described in more detail with reference to the Figures, in which embodiments of the present invention has been illustrated.

Some embodiments will be described in more detail with reference to the accompanying drawings, in which the embodiments of the present invention have been illustrated. However, the present invention can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by multiple organizations and supports a specific community that has shared concerns (e.g., mission, security requirements, policy, and compliance considerations). The cloud community cloud may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

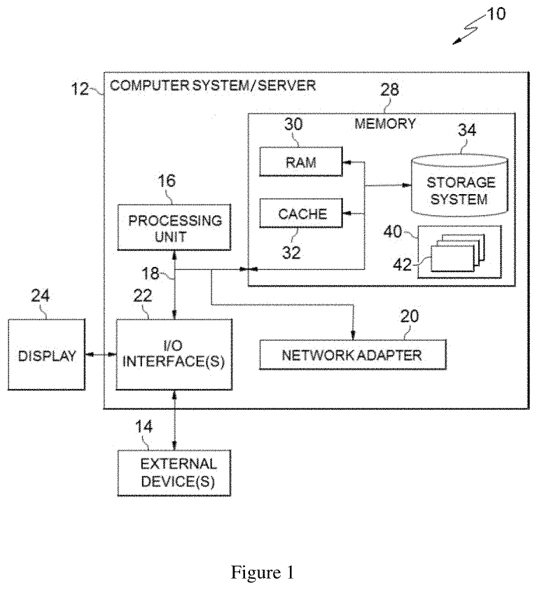

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units, a system memory 28, and a bus 18 that couples various system components including system memory 28 to processor 16.

Bus 18 represents one or more of any of multiple types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

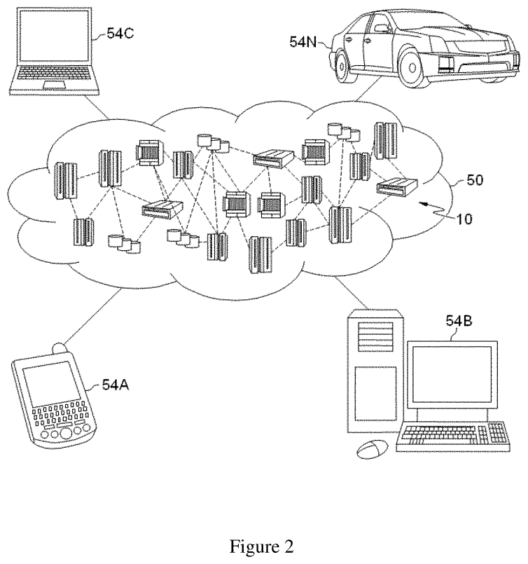

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

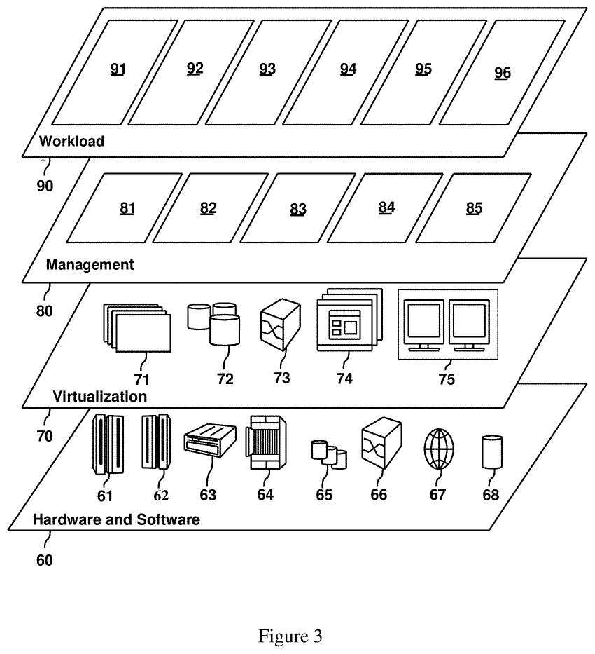

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analysis processing 94; transaction processing 95; and copy and paste operations processing 96.

One having of ordinary skill in the art would appreciate that embodiments of the present invention can be useful in scenarios where a user wants to paste discontinuous parts of the copied textual data. According to embodiments of the present invention, after the textual data is copied in an application (e.g., clipboard), the copied textual data can be obtained and split into a plurality of semantic fragments based on semantic analysis. Additionally, the fragments can be rendered for selection by a user. Furthermore, embodiments of the present invention may provide the user the ability to subjectively select a fragment of copied textual data to paste. Thus, eliminating the necessity of repeated copy and paste operations or unnecessary editing operations on the pasted data. In addition, the plurality of fragments are rendered on the screen such that the contents to be pasted are visible, which makes the paste operation more accurate and convenient. These improvements and/or advantages are a non-exhaustive list of example advantages. Embodiments of the present disclosure exist which can contain none, some, or all of the aforementioned advantages and/or improvements.

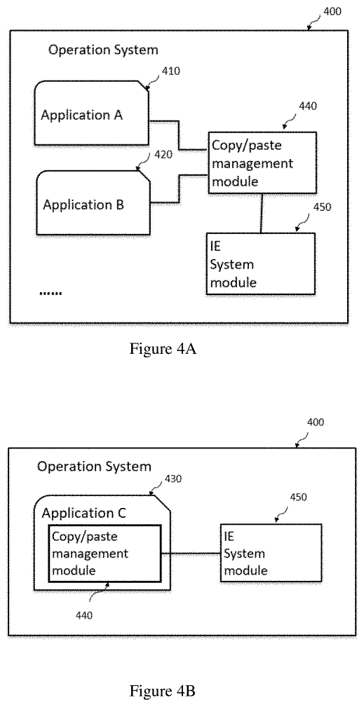

In the following, embodiments of the present invention will be described in detail with reference to FIGS. 4 to 8.

FIG. 4A depicts a block diagram of an exemplary system in which embodiments of the present invention can be implemented, in accordance with embodiments of the present invention. Referring to FIG. 4A, operation system 400 comprises at least two applications, such as application A 410 and application B 420. For example, the applications are programs or processes to implement tasks or provide functions for programs (e.g., word processing program, collaborative software platform, etc.). Also, operation system 400 includes a copy/paste management module 440 which implement functions of this invention and an information extraction (IE) system module 450, which is configured in the operation system 400. However, it should be noted that the IE system module 450 can also be configured outside the operating system 400 (not shown in FIG. 4A).

Additionally, copy/paste management module 440 can access IE system module 450 can locally or via a network, such as the Internet. In an example embodiment, different applications of operation system 400 can perform the copy operation in application A 410 and the paste operation in application B 420. For example, a copy operation may be requested in a word processing program (e.g., application A 410) and a paste operation (e.g., application B 420) is requested in a collaborative software platform. In another example embodiment, the copy operation and the paste operation may also be performed in the same application of the operation system 400 (e.g., application A 410, application B 420, etc.). For example, a copy operation may be requested in a word processing program (e.g., application A 410) and a paste operation is also requested in the word processing program (e.g., application A 410).

FIG. 4B depicts a block diagram of another exemplary system in which embodiments of the present invention can be implemented, in accordance with embodiments of the present invention. Referring to FIG. 4B, the operation system 400 comprises at least one application (e.g., application C 430). In an example embodiment, copy/paste management module 440, which implement functions of this invention, is configured in application C 430. Additionally, information extraction (IE) system module 450 is configured in operation system 400. However, it should be noted that IE system module 450 can also be configured outside the operating system 400 (not shown in FIG. 4B). Furthermore, IE system module 450 may be accessed by copy/paste management module 440 locally or via a network, such as the Internet. In this example embodiment, the copy operation and paste operation may be performed in the same application, such as application C 430. The embodiment of FIG. 4B differs from that of FIG. 4A in that copy/paste management module 440 is configured in application C 430, as opposed to being configured in the operation system 400.

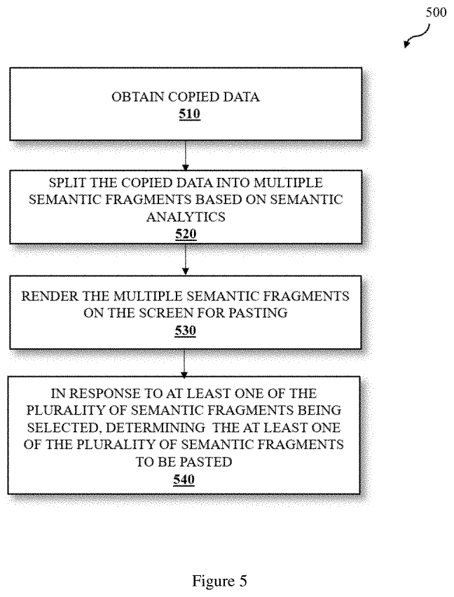

FIG. 5 is a flowchart depicting operational steps of program 500, a program for copying and pasting data, in accordance with embodiments of the present invention. In one embodiment, program 500 initiates in response to a user selecting textual data displayed on an interactive screen of a computing device. For example, program 500 initiates in response to a user highlighting text on a touchscreen of a mobile device. In various embodiments, copy/paste management module 440 can execute processes of program 500, in accordance with aspects of the present invention.

In step 510, program 500 obtains copied data. In one embodiment, program 500 obtains textual data of copy/paste management module 440. For example, program 500 retrieves copied data, which is obtained in response to a copy operation being requested by a user, from a clipboard manager (e.g., copy/paste management module 440) of a word processing program (e.g., application A 410), or from any other means of storage, which stores the copied data in response to a request from the user of an electronic device for copying data. In another embodiment, copy/paste management module 440 retrieves copied data of application A 410 from an electronic device of a user.

In step 520, program 500 splits the copied data into multiple semantic fragments based on semantic analysis. In various embodiments of the present invention, a semantic fragment may be a word, an emoji, a phrase, a sentence, any combination of thereof, or may be otherwise arrangeable through user customization, in accordance with embodiments of the present invention. In one embodiment, program 500 utilizes IE system module 450 to segment the copied data of copy/paste management module 440. For example, program 500 uses copy/paste management module 440 to call IE system module 450. In this example, IE system module 450 may be any existing information extraction (IE) system, which is an implementation of information extraction technologies based on semantic analysis.

Additionally, the IE system can include: an annotated query language (AQL), a declarative rule language with a similar syntax to structured query language (SQL); an optimizer, which accepts AQL statements as input and generates high-performance algebraic execution plans; and an executing engine, which executes the plan generated by the optimizer and performs information extraction over input documents. These technologies of IE system are existing technology and will not be described in detail herein. Furthermore, the implementation of the semantic analysis may be based on at least one of the following: meaning, grammar structure, and punctuation of the text, etc. In another example, program 500 may divide the copied data into various categories (e.g., address, date, time, etc.) as a result of information exaction. In this example, program 500 may split the copied data into a plurality of semantic fragments according to the result of information exaction.

In step 530, program 500 renders the multiple semantic fragments on the screen for pasting. In various embodiments of the present invention program 500 generates an application programming interface (API) by which a program can specify cut, copy, and paste operations for a plurality of semantic fragments that are rendered on the screen for a user to select. In one embodiment, program 500 utilizes copy/paste management module 440 to provide semantic fragments to a user. For example, program 500 display one or more semantic fragments of the copied data on a touch screen of an electronic device via a clipboard (e.g., copy/paste management module 440). In this example, each of the semantic fragments of the clipboard may be selected by an interaction with the touch screen in a location corresponding to each of the semantic fragments.

In step 540, in response to at least one of the plurality of semantic fragments being selected, program 500 determines the at least one of the plurality of semantic fragments to be pasted. In one embodiment, program 500 determines a user selection of one or more semantic fragments of copy/paste management module 440. For example, program 500 monitors a touch screen of an electronic device detect a user interaction with the touch screen. In this example, program 500 determines that a user selects one or more semantic fragments of the copied data based on the location of the user interaction and the location of the one or more semantic fragments.

In another embodiment, program 500 utilizes copy/paste management module 440 to perform a paste operation of the user selection of one or more semantic fragments in application A 410. For example, program 500 uses a clipboard (e.g., copy/paste management module 440) to perform a pasting operation in a word processing program (e.g., application A 410) that inputs at least one of user selected one or more semantic fragments into a specified field of the word processing program. In another embodiment, copy/paste management module 440 inputs one or more fragments of the user selection into application B 420.

Hereinafter, an exemplary user scenario of this invention will be described in connection with corresponding user interfaces (UI) embodying the method of the present disclosure.

In one scenario, a user would like to share detailed information (e.g., a bookstore address) with a contact by an operation of long pressing (e.g., highlighting) a position of the bookstore address on a touch screen (e.g., UI) of a smart phone the user. In this scenario, once a part of the share detailed information is highlighted, and the user may change the range of the share detailed information to select the share detailed information to be pasted by moving two cursors and conducting the copy request. Additionally, the share detailed information selected can be copied into the clipboard as copied data and is ready for following operations.

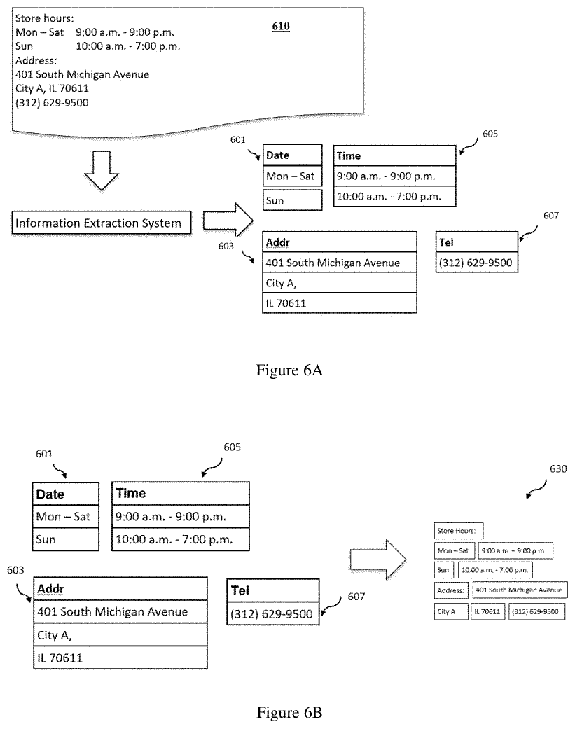

FIG. 6A shows a schematic diagram in which program 500 extracts information based on semantic analysis for the above scenario is shown. In FIG. 6A, a user would like to program 500 to share copied data (e.g. the detailed information of a bookstore address) with a friend. In this example embodiment, the copied data is referred to as 610 in FIG. 6A. Additionally, the data or the contents mentioned above for copy and paste operations on the touch sensitive screen of electronic device may comprise text, emoji, or any symbols embodied in applications. Furthermore, program 500 imports the obtained text into an IE system (e.g., IE system module 450).

Also, program 500 uses the IE system to extract individual information from bookstore address 610 and sorts the detailed information of bookstore address 610 into different categories based on semantic analysis, where the categories include Date 601, Time 605, Addr 603, and Tel 607. Furthermore, program 500 utilizes the IE system to split the detailed information into a plurality of semantic fragments based on semantic analysis. In addition, the splitting based on semantic analysis may also utilize any other appropriate existing approaches or future approaches and should not adversely limit the scope of the present invention.

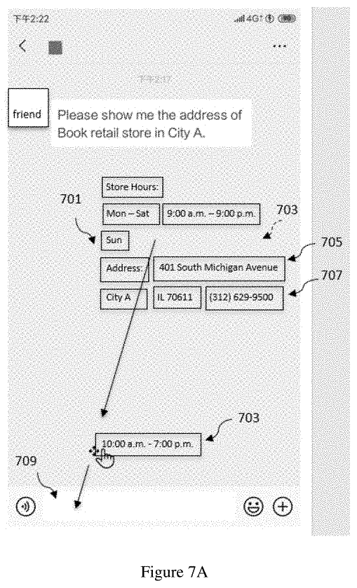

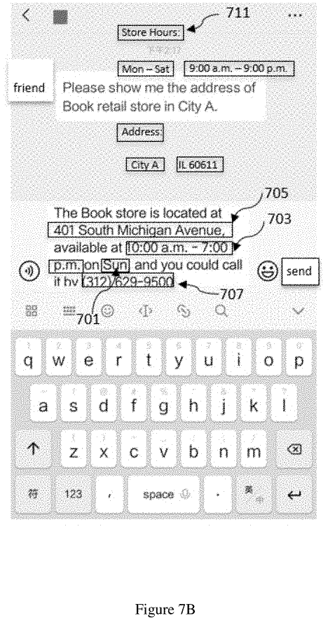

FIG. 6B shows a schematic diagram in which program 500 splits of the detailed information of bookstore address 610 of FIG. 6A. In FIG. 6B, program 500 utilizes the IE system (e.g., IE system module 450) to identify one or more categories shown in FIG. 6A (e.g., Date 601, Time 605, Addr 603, Tel 607, etc.) and fragment the detailed information of bookstore address 610 into semantic fragments 630 according to the one or more categories shown in FIG. 6A. In this example embodiment, program 500 excludes the names of the one or more categories, such that the one or more categories are not included in semantic fragments 630. Additionally, the detailed information in the original contents of copied text of bookstore 610, which program 500 excludes and are not classified by the IE system, may remain unchanged and form separate fragments, such as fragment 711 shown in FIG. 7B.

In various embodiments of the present invention, if program 500 determines that in addition to semantic fragments 630 (shown in FIG. 6B), a selection for all copied data (not shown) may be provided by the user in to paste the continuous contents of detailed information of bookstore address 610 using an existing method. Additionally, the present invention is not intended to replace the existing method, but rather to preserve the existing method and provide additional features or options for users to conduct the paste operation. For example, program 500 determines that a user selects a method of present invention by short pressing the position of the data on the screen (e.g., selecting semantic fragments 630) and determines that the user selects the existing method by long pressing the position of the data on the screen (i.e., select all). In another example, program 500 may provide copied data of bookstore address 610 and semantic fragments 630 on a screen of an electronic device of a user based on a selection of the user.

FIG. 7A shows an example embodiment of a user interface (UI) of the above scenario, in which the rendered semantic fragments 630 and one selected fragment to be pasted in specified field 709 are shown. In this example embodiment, the UI shown in FIG. 7A, program 500 renders semantic fragments 630 that include fragment 701, fragment 703, fragment 705, and fragment 707. Additionally, program 500 determines that a user selects at least one of semantic fragments 630 and utilizes IE system module 450 to perform a paste operation of the selected fragment (e.g., fragment 703) in specified field 709. Furthermore, program 500 determines that fragment 703 in FIG. 7A is a first selection of a user, and the user drags and drops fragment 703 into specified field 709. Additionally, program 500 may input fragment 703 of semantic fragments 630 into specified field 709 in response to the drag and drop action of the user. As a result, fragment 703 is moved to or pasted into specified field 709.

FIG. 7B shows an example embodiment of a user interface (UI) of the above scenario, in which the rendered semantic fragments 630 to be pasted (e.g. fragment 701, fragment 703, fragment 705, and fragment 707) in a specified field are shown in FIG. 7B. In this example embodiment, during the interval of pasting, some edit operations may be conducted by the user, such as typing “available at” or inputting “available at” by speech recognition between pasting fragment 705 and fragment 703. Additionally, as can be seen from this example embodiment, only fragment 705, fragment 703, fragment 701, and fragment 707 need to be pasted in order from the copied text, but not all the text.

However, it should be noted that the pasting operations of the selected at least one of the plurality semantic fragments should not be limited. As mentioned above, the paste operation may be initiated by a user to drag and drop the selected at least one of the plurality of semantic fragments to the specified field or to click the selected at least one of the plurality of semantic fragments respectively at the specified field so that the selected at least one of the plurality of semantic fragments may be input into the specified field.

As discussed in the above embodiments of the present invention, the screen of the electronic device is not limited to a touch sensitive screen. Additionally, the user interface (UI) rendering/displaying the semantic fragments may be in any form, such as blocks (e.g. the blocks shown in FIG. 7), any other graphics, or simply separate the fragments with spaces without any graphics, etc. Alternatively, the semantic fragments may be rendered in a popped-up dialog, a floating window, or in any other suitable means of displaying information in an operating system. The order of the fragments in the UI can be formatted in the original arrangement as shown in the examples of the figures or can be arranged in various other arrangements.

According to some embodiments of the present invention, the plurality of semantic fragments may be rendered in order according to respective priorities of the semantic fragments for pasting. Additionally, the fragment with high priority or closest to the cursor may be highlighted with different colors to represent different priorities. Regarding the priority for each of the fragments, the priority may be obtained by existing methods of machine learning and/or data analysis and will not be discussed in detail herein.

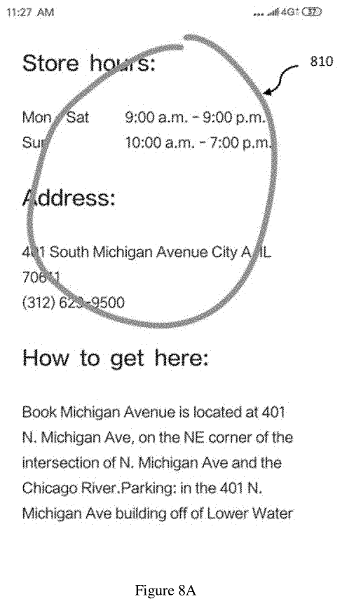

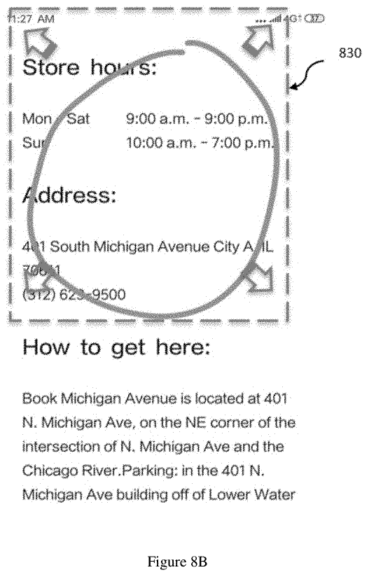

According to some embodiments of the present invention, an application may not display the rendered fragments when receiving a next instruction, or when a blank area on a screen is clicked. With respect to a copy operation, the copy operation may be completed in any approach in response to a request for the copy operation from an electronic device of a user. As mentioned above, the copy operation may be conducted by a user through long pressing the position of the data on the touch sensitive screen, which is known to a person of ordinary skill in the art. The present invention also discloses another copy operation method which will be described in detail below with reference to FIGS. 8A and 8B. However, it should be noted that the copy operation may also utilize any other appropriate approaches existing or developed in the future and should not adversely limit the scope of the disclosure as shown in FIG. 5.

Referring now to FIGS. 8A and 8B, a schematic diagram of an example method of a copy operation is depicted in accordance with embodiments of the present invention. In an example embodiment, program 500 detects a gesture (e.g., a graphic drawn by the user) a user on an UI of an electronic device. Additionally, in response to program 500 determining that a user long presses a position of text on a touch sensitive screen of the electronic device, program 500 initiates a copy operation. Also, the text may be highlighted, and movable cursors may be displayed on the left side and the right side of the highlighted text respectively, which can be moved to change the range of text to be copied. However, in above existing copy operation, embodiments of the present invention recognize that challenges exist in moving the cursors to an accurate position on the screen of the electronic device with a limited size for a user with a finger. Embodiments of the present invention recognize a need for a more convenient and efficient way for conducting copying operation.

Embodiments of the present invention provides a method to copy a paragraph of content, in which the data to be copied needs not to be precisely selected, but an area or range on the touch sensitive screen that roughly includes the data to be copied can be selected by a user using a finger gesture (e.g., closed graphics, semi-closed graphics, various lines, underlines, etc.) to cover or indicate a certain area or range of the content on the screen can be drawn. In various embodiments of the present invention the gesture is referred to as a drawn gesture hereafter.

In an example embodiment, an address of a store is returned from a website and program 500 performs a copy operation utilizing a drawn gesture of a user shown in FIG. 8A. FIG. 8A includes nearly closed graphic 810 that is similar to a circle, which is drawn by the user. Additionally, nearly closed graphic 810 is received by the touch sensitive screen of the computing device using a UI. Also, nearly closed graphic 810 is not limited to a circle as shown in FIG. 8A, but may be similar to an oval, square, lines or any other arbitrary or suitable shape.

In this example embodiment, program 500 identifies a range of nearly closed graphic 810 and adjusts or extends the range to a rectangle 830 as shown in FIG. 8B, which includes the highest point, the lowest point, the leftmost point and the rightmost of the graphic. However, the adjustment of the range to rectangle 830 is not limited to this example embodiment and may include maximizing the scope of the selected text or extending the incomplete sentence in the text to the nearest punctuation, or any other customization of adjustment in accordance with the teachings of the present invention. Additionally, program 500 may adjust the range by implementing an existing loop statement or any other existing approaches or approaches developed in the future and will not be discussed in detail herein. Furthermore, program 500 utilizes copy/paste management module 440 to obtain the data contained in the adjusted range of rectangle 830 for copying and pasting. The method of the present embodiment of the invention compared with existing solutions, the copy method in present invention may select the data to be copied roughly so the copied data may be selected more conveniently and efficiently.

However, it should be noted that the processing of pasting or pasting apparatus according to embodiments of the present invention could be implemented by computer system/server 12 of FIG. 1.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more processors, a gesture of a user on a display of a computing device, wherein the display is a touch sensitive screen and the gesture is a graphic drawn by the user;
in response to identifying a copy operation request based at least in part on the gesture, obtaining, by one or more processors, copied data;
splitting, by one or more processors, the copied data into a plurality of semantic fragments based on semantic analysis;
determining, by one or more processors, a priority ranking of each of the plurality of semantic fragments;
rendering, by one or more processors, the plurality of semantic fragments on a display of a computing device based at least in part on the priority ranking of each of the plurality of semantic fragments; and
in response to identifying a user selection of at least one of the plurality of semantic fragments, determining, by one or more processors, whether to paste the at least one of the plurality of semantic fragments.

2. The method of claim 1, further comprising:
pasting, by one or more processors, the determined at least one of the plurality of semantic fragments into a specified field.

3. The method of claim 1, wherein each of the plurality of semantic fragments comprises at least one of the following selected from a group consisting of: a word, a phrase, an emoji, and a sentence.

4. The method of claim 1, wherein the semantic analysis of the copied data based on at least one of the following selected from a group consisting of: meaning, grammar structure, and punctuation.

5. The method of claim 2, wherein the pasting the at least one of the plurality of semantic fragments to the specified field, further comprises:
in response to the at least one of the plurality of semantic fragments being dragged and dropped, inputting, by one or more processors, the at least one of the plurality of semantic fragments to the specified field.

6. The method of claim 1, further comprising:
identifying, by one or more processors, a selection for all of the copied data for pasting.

7. The method of claim 1, wherein rendering the plurality of semantic fragments on the display of the computing device, further comprises:
rendering, by one or more processors, the plurality of semantic fragments on the display of the computing device in an order based on priorities of the semantic fragments for pasting.

8. The method of claim 1, further comprising:
identifying, by one or more processors, a range of the graphic;
adjusting, by one or more processors, the range, wherein the adjusted range is extended based at least in part on the graphic and textual data of the graphic;
obtaining, by one or more processors, the textual data of the adjusted range; and
copying, by one or more processors, the textual data of the adjusted range.

9. A computer program product comprising:
one or more computer readable storage media and program instructions stored on the one or more computer readable storage media, the program instructions comprising:
program instructions to identify a gesture of a user on a display of a computing device, wherein the display is a touch sensitive screen and the gesture is a graphic drawn by the user;
in response to identifying a copy operation request based at least in part on the gesture, program instructions to obtain copied data;
program instructions to split the copied data into a plurality of semantic fragments based on semantic analysis;
program instructions to determine a priority ranking of each of the plurality of semantic fragments;
program instructions to render the plurality of semantic fragments on a display of a computing device based at least in part on the priority ranking of each of the plurality of semantic fragments; and
in response to identifying a user selection of at least one of the plurality of semantic fragments program instructions to determine whether to paste the at least one of the plurality of semantic fragments.

10. The computer program product of claim 9, further comprising program instructions, stored on the one or more computer readable storage media, to:
paste the determined at least one of the plurality of semantic fragments into a specified field.

11. The computer program product of claim 9, wherein each of the plurality of semantic fragments comprises at least one of the following selected from a group consisting of: a word, a phrase, an emoji, and a sentence.

12. The computer program product of claim 9, wherein the semantic analysis of the copied data based on at least one of the following selected from a group consisting of: meaning, grammar structure, and punctuation.

13. The computer program product of claim 10, wherein program instructions to paste the determined at least one of the plurality of semantic fragments into the specified field, further comprise program instructions to:
in response to the at least one of the plurality of semantic fragments being dragged and dropped, input the at least one of the plurality of semantic fragments to the specified field.

14. The computer program product of claim 9, further comprising program instructions, stored on the one or more computer readable storage media, to:
identify a selection for all of the copied data for pasting.

15. The computer program product of claim 9, wherein program instructions to render the plurality of semantic fragments on the display of the computing device, further comprise program instructions to:
render the plurality of semantic fragments on the display of the computing device in an order based on priorities of the semantic fragments for pasting.

16. The computer program product of claim 9, further comprising program instructions, stored on the one or more computer readable storage media, to:
identify a range of the graphic;
adjusting the range wherein the adjusted range is extended based at least in part on the graphic and textual data of the graphic;
obtaining the textual data of the adjusted range; and
copying the textual data of the adjusted range.

17. A computer system comprising:
one or more computer processors;
one or more computer readable storage media; and
program instructions stored on the computer readable storage media for execution by at least one of the one or more processors, the program instructions comprising:
program instructions to identify a gesture of a user on a display of a computing device, wherein the display is a touch sensitive screen and the gesture is a graphic drawn by the user;
in response to identifying a copy operation request based at least in part on the gesture, program instructions to obtain copied data;
program instructions to split the copied data into a plurality of semantic fragments based on semantic analysis;
program instructions to determine a priority ranking of each of the plurality of semantic fragments;
program instructions to render the plurality of semantic fragments on a display of a computing device based at least in part on the priority ranking of each of the plurality of semantic fragments; and
in response to identifying a user selection of at least one of the plurality of semantic fragments program instructions to determine whether to paste the at least one of the plurality of semantic fragments.

18. The computer system of claim 17, further comprising program instructions, stored on the one or more computer readable storage media for execution by at least one of the one or more processors, to:
paste the determined at least one of the plurality of semantic fragments into a specified field.

19. The computer system of claim 17, wherein each of the plurality of semantic fragments comprises at least one of the following selected from a group consisting of: a word, a phrase, an emoji, and a sentence.

20. The computer system of claim 17, wherein the semantic analysis of the copied data based on at least one of the following selected from a group consisting of: meaning, grammar structure, and punctuation.
